(19) United States
(12) Patent Application Publication
(10) Pub. No.: US 2006/0198952 A1
(43) Pub. Date: Sep. 7, 2006

(54) Method of applying protective layer forming material

(76) Inventors: Bansei Nagase, Sayama-shi, Saitama-ken (JP); Hidehiko Tokonami, Saitama-ken (JP); Hiromi Okubo, Saitama-ken (JP); Hitoshi Imamura, Saitama-ken (JP)

Correspondence Address: FISH & RICHARDSON P.C., P.O. BOX 1022, MINNEAPOLIS, MN, 55440-1022, US

(21) Appl. No.: 10/551,055

(22) PCT Filed: Mar. 26, 2004
(86) PCT No.: PCT/JP04/04275

§ 371 Date: Sep. 26, 2005

(30) Foreign Application Priority Data
Mar. 27, 2003 (JP) 2003-088285
Mar. 28, 2003 (JP) 2003-091543
Apr. 16, 2003 (JP) 2003-111988

(51) Int. Cl. C09D 5/00

(52) U.S. Cl. 427/154

(57) ABSTRACT

A method of applying a protective layer forming material, wherein when a roller is rolled against a curved portion of a vehicle to apply the protective layer forming material, the roller is rolled at a speed that is lower than a speed when the protective layer forming material is applied by rolling the roller over a generally flat portion of the vehicle. When the roller is rolled against a portion of the vehicle having recessed and projected grooves, in order to apply the protective layer forming material, an axis of the roller is positioned generally horizontal to an extending direction of the grooves and the roller moves in a direction generally perpendicular to the extending direction of the grooves, while the roller is rolled at a speed that is lower than a speed when the protective layer forming material is applied over the generally flat portion.

### TECHNICAL FIELD

The present invention relates to a method of applying a protective layer forming material to an outer surface, which comprises primarily a painted area of a motor vehicle that has been painted, and more particularly to a method of applying a protective layer forming material in a liquid form, which will act as a peelable protective layer after being dried.

### BACKGROUND ART

After being manufactured, vehicles such as automobiles are often stored in an outdoor stockyard or transported by a trailer, a ship, or the like until they are delivered to users. Since the vehicles are exposed to dust, metal particles, salt, oil, acid, direct sunlight, etc. while they are in storage or transportation, the surfaces of coating layers on the outer surface of such vehicles tends to become lower in quality. To prevent the surface layer from being deteriorated, there is known a process of forming a peelable protective layer over the painted area before the vehicle is shipped out (see, for example, Japanese Laid-Open Patent Publication No. 2001-89697).

The peelable protective layer is formed by applying and drying a protective layer forming material (also called “strippable paint”), which serves as a liquid wrap material that can protect the painted area. The protective layer forming material can easily be peeled off when it is to be removed. However, the protective layer does not peel off of its own when in normal storage.

For applying the protective layer forming material to be dried into the peelable protective layer, the protective layer forming material is applied to rollers, and the rollers are rolled by a plurality of workers to coat the surface layer with the protective layer forming material.

In order to automate the coating process and have the coating quality be uniform, there has been proposed a process of pouring a protective layer forming material onto a body and applying air to spread the protective layer forming material (see, for example, Japanese Laid-Open Patent Publication No. 8-173882). According to the proposed process, numerous steps of the process for applying the protective layer forming material are automated, in order to lower the burden on workers and increase tact time.

In factories for producing vehicles, it is customary to temporarily cover vehicle bodies with resin-made covers, known as scratch covers, in order to prevent the vehicle bodies from being damaged during the assembly process. A scratch cover is temporarily applied to a front lateral surface of a vehicle body, and removed before the vehicle is shipped out. It is necessary to prepare scratch covers having different shapes for different vehicle types, and also to prepare a large number of scratch covers depending on the number of vehicles to be produced on a daily basis on the conveyor line.

According to the process disclosed in Japanese Laid-Open Patent Publication No. 8-173882, the protective layer forming material is not necessarily spread uniformly. Also, the disclosed process is not applied to roof edges, in order to prevent the protective layer forming material from being scattered.

Recent vehicle bodies are becoming more complex in shape, and some of them have convexities and concavities, with complex and delicate curved surfaces. It is difficult to spread the protective layer forming material with an air nozzle over such convexities and concavities, and on curved surfaces. Furthermore, although it is necessary to apply the protective layer forming material at a greater thickness in areas where the coating quality is of particular importance, it is difficult to adjust the thickness of the coating film when the protective layer forming material is spread by means of an air nozzle.

Consequently, after the protective layer forming material is spread by an air nozzle, workers are required to coat small spots, such as roof edges, convexities and concavities, etc., with the protective layer forming material using a roller, in order to complete the coating process. The process of applying the protective layer forming material is thus performed partly manually, and therefore is burdensome on workers and results in different coating quality levels depending on the skill level of the workers.

In order to reduce the burden on workers and make the job quality level more uniform, the use of industrial robots may be considered. However, rollers and holders therefor, which can be mounted on robots and are suitable for applying the protective layer forming material, have not yet been proposed. Since modern automobile bodies are of complex shape, it is difficult to hold a roller in close contact with an automobile body, and press the roller against the automobile body with appropriate force. Especially, when a vehicle surface near an opening, such a sunroof hole in the roof of the vehicle, is to be coated with a protective layer forming material by means of a robot, the protective layer forming material may possibly drop into the vehicle if a portion of the roller rolls into the opening.

When a worker uses a roller to apply a protective layer forming material, it is customary for the worker to apply appropriate forces depending on the shape and curvature of the surface to be coated, and to roll the roller, while keeping the holder that holds the roller at a suitable angle. In this case, the worker unconsciously adjusts the pressing force and angle of the holder, depending on the skill of the worker.

The skill of the worker is not represented by numerical values and therefore cannot be directly applied to the operation of robots. Even if the skill of the worker could be represented by numerical values, such values may not necessarily be suitable for use with robots. Nevertheless, there have been demands for a suitable coating method, which can be applied through the operation of robots.

### DISCLOSURE OF THE INVENTION

The present invention has been made in view of the above drawbacks. It is an object of the present invention to provide a method of applying a protective layer forming material, the method being capable of further automating the process of applying the protective layer forming material to an outer surface of a workpiece, while holding a roller in close contact with the outer surface of the workpiece depending on the shape thereof at all times, in order to appropriately apply the protective layer forming material.

Another object of the present invention is to provide a method of applying a protective layer forming material to an outer surface of a workpiece with a roller of a coating apparatus, wherein the method is capable of appropriately pressing the roller depending on the shape of the surface of the workpiece, in order to apply the protective layer forming material reliably and efficiently.

Still another object of the present invention is to provide a method of applying a protective layer forming material appropriately to a surface of a workpiece, even in the vicinity of an opening such as a sunroof hole, without allowing the protective layer forming material to drop into the opening.

In order to achieve the above objects, in accordance with the present invention, a method is provided for applying a protective layer forming material by rolling a roller mounted on a roller mechanism over a surface of a workpiece, using a trainable coating apparatus disposed near a conveying line for conveying the workpiece, and applying the protective layer forming material in a liquid form to the surface of the workpiece, which is supplied to the roller and which will act as a peelable protective layer after being dried, the method comprising the steps of, when the roller is rolled over a curved area of the workpiece, rolling the roller at a speed lower than when the roller is rolled over a substantially flat area of the workpiece, and, when the roller is rolled over an area having a groove of the workpiece, orienting an axis of the roller substantially parallel to a direction in which the groove extends, moving the roller in a direction substantially perpendicular to the direction in which the groove extends, pressing the roller against the groove, and rolling the roller at a speed lower than when the roller is rolled over a substantially flat area of the workpiece.

The roller mechanism is thus pressed by the trainable coating apparatus against the substantially flat surface of the workpiece, effectively utilizing its own weight as a pressing force. The roller of the roller mechanism is supplied with the protective layer forming material, and is rotated while being pressed against the surface of the workpiece, to thereby appropriately apply the protective layer forming material to the surface of the workpiece.

By rolling the roller at a speed lower than when the roller is rolled on the substantially flat surface of the workpiece, the roller can reliably apply the protective layer forming material to a curved area of the workpiece.

Furthermore, the roller mechanism is pressed by the trainable coating apparatus against the substantially flat surface of the workpiece, effectively utilizing its own weight as a pressing force. The roller of the roller mechanism is supplied with the protective layer forming material, and is rotated while being pressed against the surface of the workpiece, to thereby appropriately apply the protective layer forming material to the surface of the workpiece.

While the roller mechanism is pressed inside the groove, the roller of the roller mechanism is oriented substantially parallel to the direction in which the groove extends, and is moved in a direction substantially perpendicular to the direction in which the groove extends. In addition, the roller is moved at a speed lower than when the roller is rolled over the substantially flat surface of the workpiece, thereby reliably applying the protective layer forming material to the surface of the groove.

The roller mechanism may have a swinging mechanism for swinging the roller about a swing shaft in a direction perpendicular to the axis of the roller. A maximum angle for a tilt angle of a straight line interconnecting the swing shaft and the axis of the roller, with respect to a surface of the workpiece to be coated, may be set to an increased value depending on the magnitude of curvature of the surface of the workpiece to be coated.

By thus setting the maximum angle for the tilt angle to an increased value depending on the magnitude of curvature of the surface of the workpiece to be coated, the roller can appropriately be pressed against the surface of the workpiece depending on the shape of the surface.

The tilt angle may be set at a value ranging from 25° to 35° for a surface to be coated having the smallest curvature, and the tilt angle may be set at a value ranging from 25° to 65° for a surface to be coated having the greatest curvature.

If a pressing means is provided, for pressing the roller against the surface of the workpiece to be coated, then the pressing force applied by the roller to the surface of the workpiece to be coated can be compensated for.

The coating apparatus may be moved at a lower speed as the tilt angle thereof increases.

According to the present invention, a method is also provided for applying a protective layer forming material by rolling a roller mounted on a roller mechanism over a surface of a workpiece, using a trainable coating apparatus disposed near a conveying line for conveying the workpiece, and applying the protective layer forming material in a liquid form to the surface of the workpiece, which is supplied to the roller and which will act as a peelable protective layer after being dried, the method comprising the steps of, when the roller mounted on the roller mechanism is pressed against and rolled over the workpiece near an opening edge that defines an opening in the workpiece, setting an axis of the roller at an acute angle to a direction in which the opening edge extends, and rolling the roller along the opening edge to apply the protective layer forming material to the surface of the workpiece near the opening by the coating apparatus.

According to the above method, when the roller is set at an acute angle to the opening edge and is rolled to apply the protective layer forming material, the area of the roller which is pressed against the surface of the workpiece becomes progressively smaller, and the area of the roller which is positioned over the opening becomes progressively greater. As a result, even when the protective layer forming material moves from a pressed end of the roller toward the other end of the roller that is not pressed, the protective layer forming material is sufficiently absorbed by the roller and is prevented from dropping into the opening.

According to the present invention, a method is further provided for applying a protective layer forming material by rolling a roller mounted on a roller mechanism over a surface of a workpiece, using a trainable coating apparatus disposed near a conveying line for conveying the workpiece, and applying the protective layer forming material in a liquid form to the surface of the workpiece, which is supplied to the roller and which will act as a peelable protective layer after being dried, the method comprising the steps of, when the roller mounted on the roller mechanism is pressed against and rolled over the workpiece near an opening edge that defines an opening in the workpiece, inclining the roller to press one end of the roller against the surface of the workpiece, while allowing the other end of the roller to float over the opening, and rolling the roller along the opening edge to apply the protective layer forming material to the surface of the workpiece near the opening by the coating apparatus.

According to the present invention, since the roller is pressed against the opening edge, such that the other end of the roller floats at a position higher than the one end thereof, the protective layer forming material contained in the roller is more liable to move through the roller toward the other end thereof, and thus is prevented from dropping into the opening.

In a preferred configuration, the coating apparatus comprises a robot and the workpiece comprises a vehicle, wherein the robot can move along complex shapes of the vehicle.

The protective layer forming material may comprise an acrylic copolymer as a chief component thereof.

The acrylic copolymer can quickly and easily be applied to the workpiece as the protective layer forming material for protecting painted areas of the workpiece more reliably, and can easily be peeled off and removed when necessary.

### BRIEF DESCRIPTION OF THE DRAWINGS

FIG. 1 is a perspective view of a system for applying a protective layer forming material;

FIG. 2 is a front elevational view of the system for applying a protective layer forming material;

FIG. 3 is a perspective view of a robot and a roller mechanism mounted on the robot;

FIG. 4 is an enlarged perspective view of the roller mechanism;

FIG. 5 is an enlarged front elevational view, partly in cross section, of the roller mechanism;

FIG. 6 is an enlarged side elevational view, partly in cross section, of the roller mechanism;

FIG. 7 is a circuit diagram of a composite hydraulic and pneumatic circuit;

FIG. 8 is a view illustrating the manner in which the robot moves to the right, while applying the protective layer coating material, in a pneumatic cylinder circuit;

FIG. 9 is a view illustrating the positional relationship between the robot and the surface of the vehicle when the robot with the roller mechanism moves to the left;

FIG. 10 is a view illustrating the positional relationship between the robot and the surface of the vehicle when the robot applies the protective layer coating material, while rods of left and right pneumatic cylinders of the roller mechanism are retracted;

FIG. 11 is a view illustrating the positional relationship between the robot and the surface of the vehicle when the robot applies the protective layer coating material, while the rods of the left and right pneumatic cylinders of the roller mechanism are extended;

FIG. 12 is a view illustrating the positional relationship between the robot and the surface of the vehicle when the robot applies the protective layer coating material along relatively deep grooves, and while the rods of left and right pneumatic cylinders of the roller mechanism are retracted under strong forces;

FIG. 13 is a perspective view showing the roller oriented in alignment with grooves formed on the outer surface of the vehicle;

FIG. 14 is a plan view showing the roller oriented in alignment with grooves formed on the outer surface of the vehicle;

FIG. 15 is a perspective view illustrating the positional relationship between the robot and the surface of the vehicle when the robot applies the protective layer coating material to roof edges and engine hood edges of the vehicle;

FIG. 16 is a view illustrating the positional relationship between the robot and the surface of the vehicle when the robot with the roller mechanism moves to the right along the roof of the vehicle;

FIG. 17 is a view illustrating the positional relationship between the robot and the surface of the vehicle when the robot with the roller mechanism moves to the right along the engine hood of the vehicle;

FIG. 18 is a view illustrating the positional relationship between the robot and the surface of the vehicle, in which a third arm of the robot is disposed on the axis of a swing shaft, when the robot with the roller mechanism moves to the right along the roof of the vehicle;

FIG. 19 is a view illustrating the positional relationship between the robot and the surface of the vehicle when the robot with the roller mechanism moves to the left along the roof of the vehicle;

FIG. 20 is a perspective view of a roller mechanism having a spring used as a pressing means;

FIG. 21 is a perspective view of a roller mechanism from which a pressing means is omitted;

FIG. 22 is a perspective view showing the manner in which the protective layer forming material is applied by moving a roller along an opening edge of a roof;

FIG. 23 is a vertical cross-sectional view showing the relationship between the roller and the opening shown in FIG. 22;

FIG. 24 is a plan view illustrating the manner in which the protective layer forming material is applied by a roller that is held at an obtuse angle with respect to the direction in which an opening edge of a roof extends;

FIG. 25 is a vertical cross-sectional view showing the relationship between the roller and the opening shown in FIG. 24;

FIG. 26 is a plan view illustrating the manner in which the protective layer forming material is applied by a roller that is held at an acute angle with respect to the direction in which an opening edge of a roof extends;

FIG. 27 is a vertical cross-sectional view showing the relationship between the roller and the opening shown in FIG. 26; and

FIG. 28 is a vertical cross-sectional view illustrating the manner in which the protective layer forming material is applied by a roller that is tilted toward the roof along an opening edge of the roof.

### BEST MODE FOR CARRYING OUT THE INVENTION

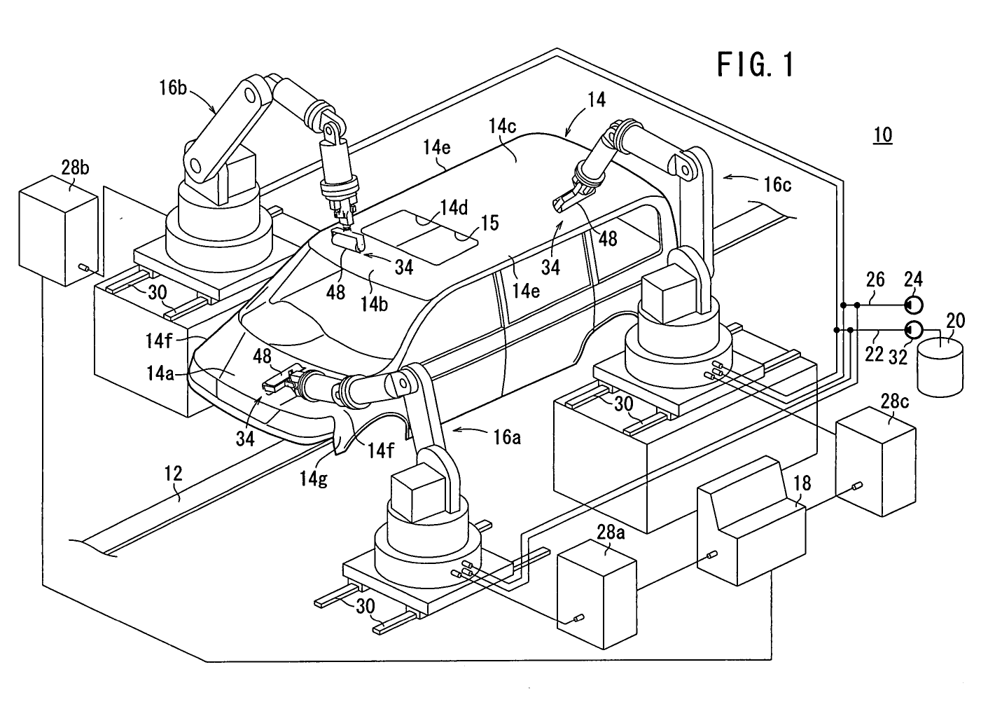

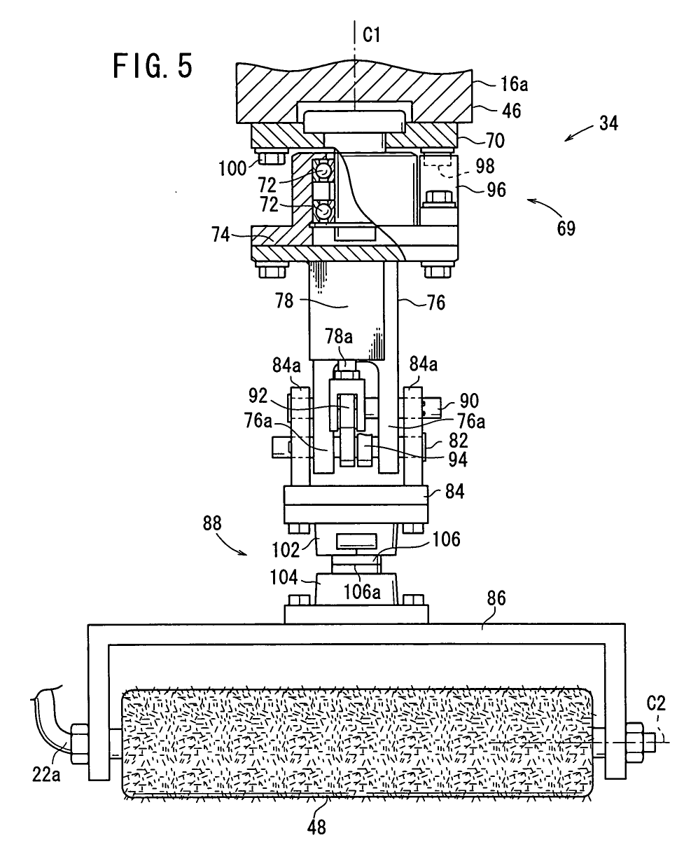

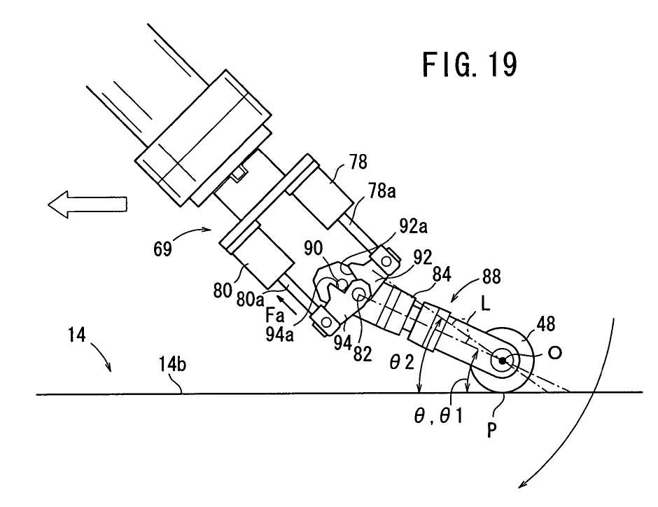

A preferred embodiment of a method for applying a protective layer forming material according to the present invention shall be described below with reference to FIGS. 1 through 28 of the accompanying drawings.

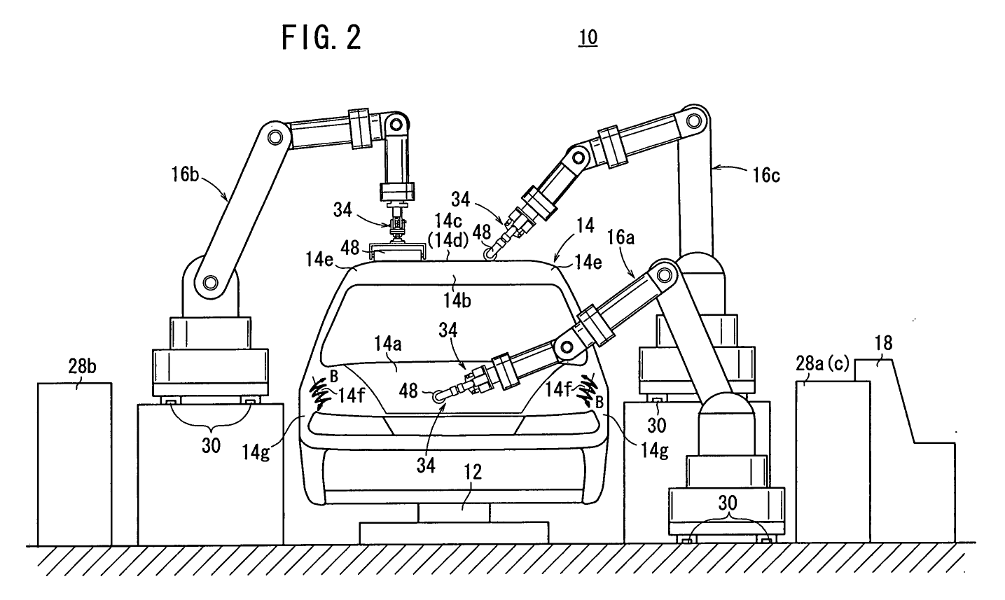

As shown in FIGS. 1 and 2, a coating system 10, which is used in the method of applying the protective layer forming material according to the present embodiment, is disposed on a vehicle (workpiece) conveying line 12, for coating a painted vehicle 14 with a protective layer forming material.

The coating system 10 has three robots 16a, 16b, 16c each comprising an industrial robot, a control console 18 for controlling the coating system 10 in its entirety, a tank 20 storing the protective layer forming material therein, a coating material pipe 22 extending from the tank 20 to the robots 16a, 16b, 16c, and a water pipe 26 for supplying water from a water source 24 to the robots 16a, 16b, 16c. The robots 16a, 16b, 16c are controlled by respective robot controllers 28a, 28b, 28c that are connected to the control console 18.

Assuming that the vehicle 14 to be coated is a wagon-type vehicle, then the vehicle 14 includes an engine hood 14a having a complex shape and a surface of large curvature, together with a roof 14b having a substantially flat surface. Although not shown, sedan-type vehicles generally have a trunk lid having a substantially flat surface.

The robots 16a and 16c are disposed on the left side of the conveying line 12 with respect to the conveying direction of the vehicle 14, whereas the robot 16b is disposed on the right side of the conveying line 12. The robots 16a is disposed in a front position, the robot 16b in a middle position, and the robot 16c in a rear position along the conveying direction of the vehicle 14. The robots 16a, 16b, 16c are movable on slide rails 30 parallel to the conveying line 12.

A pump 32 is connected to the coating material pipe 22, for drawing the protective layer forming material from the tank 20, and supplying the protective layer forming material to the robots 16a, 16b, 16c. The protective layer forming material is controlled to have a suitable temperature by a heater and thermometer, not shown. The robots 16a, 16b, 16c have roller mechanisms 34 disposed on their arm ends, which are supplied with the protective layer forming material through the coating material pipe 22.

The protective layer forming material is chiefly made of an acrylic copolymer, and preferably includes two acrylic copolymers having different glass transition temperatures. Specifically, the protective layer forming material may be the protective layer forming material disclosed in Japanese Laid-Open Patent Publication No. 2001-89697 referred to above. The protective layer forming material has a viscosity that is adjustable depending on a ratio of water mixed therewith and temperature change. When the protective layer forming material is dried, it is held in close contact with the vehicle 14, thereby chemically and physically protecting the painted areas of the vehicle 14 from dust, metal particles, salt, oil, acid, direct sunlight, etc. The protective layer forming material can easily be peeled off to remove the protective layer when the vehicle 14 is delivered to the user.

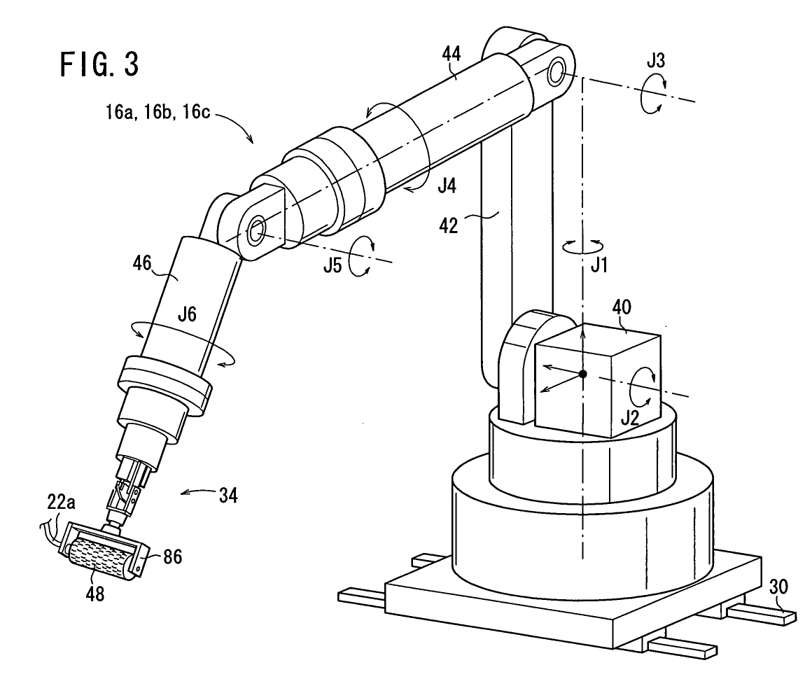

As shown in FIG. 3, each of the robots 16a, 16b, 16c comprises an industrial articulated robot, for example, including a base 40, with a first arm 42, a second arm 44, and a third arm 46, which successively extend from the base 40. The roller mechanism 34 is removably mounted on a tip end of the third arm 46, and operates as a so-called end effector. The first arm 42 is horizontally and vertically rotatable with respect to the base 40 about axes J1, J2. The second arm 44 is connected to the first arm 42 for rotation about an axis J3. The second arm 44 can be twisted about an axis J4. The third arm 46 is connected to the second arm 44 for rotation about an axis J5. The third arm 46 can be twisted about an axis J6.

The roller mechanism 34 connected to the tip end of each of the robots 16a, 16b, 16c can be moved to any desired position near the vehicle 14, and can be oriented in any direction by movement of the 6-axis robots 16a, 16b, 16c. Stated otherwise, the roller mechanism 34 is movable with six degrees of freedom. The robots 16a, 16c, 16c may have actuators for enabling expansion and contraction, parallel link motion, etc., in addition to rotation.

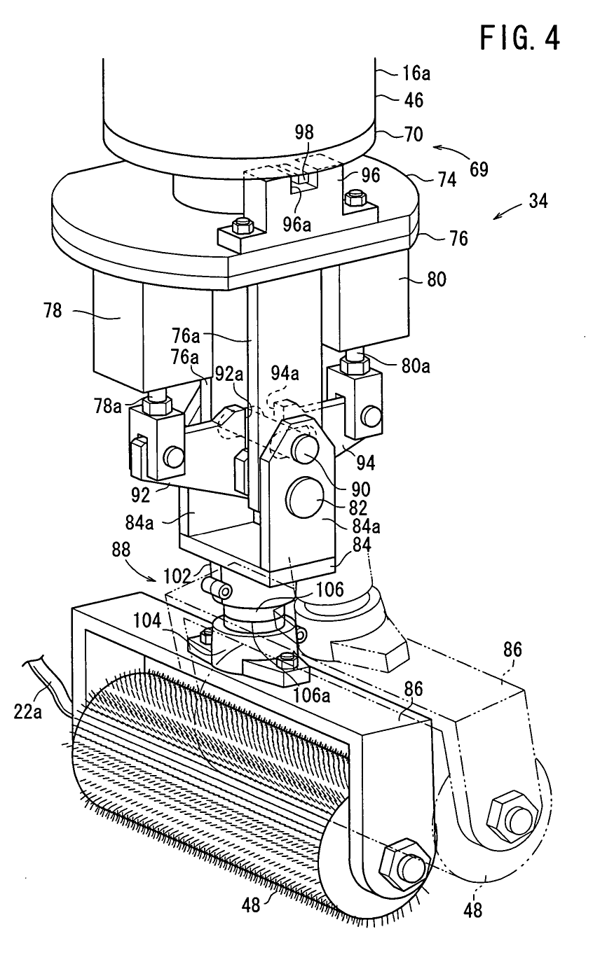

As shown in FIGS. 4 through 6, the roller mechanism 34 is mounted on the tip end of the third arm 46, and has a hollow cylindrical roller 48 made of a material capable of absorbing and holding the protective layer forming material, along with a thrust rotating mechanism 69 serving as a mount installed on the third arm 46 of the robot 16a. The thrust rotating mechanism 69 comprises a mount member 70 attached to the third arm 46, a thrust rotating member 74 rotatably supported on the mount member 70 by a bearing 72, and a base 76 mounted on a lower surface of the thrust rotating member 74.

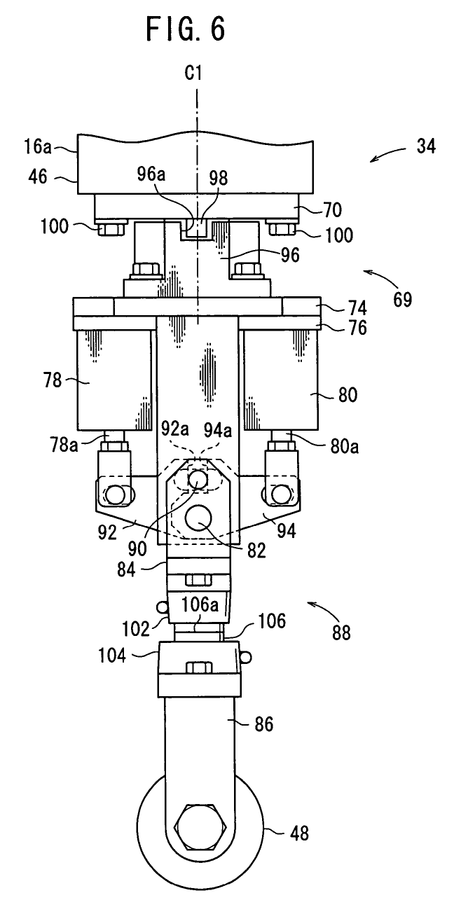

The roller mechanism 34 also has pneumatic cylinders 78, 80 mounted-on respective opposite ends of the base 76, a swing member 84 swingably supported by a swing shaft 82 on a substantially lower end of the base 76, and a holder connector 88 interconnecting a holder 86 which holds the roller 48 and the swing member 84. The roller 48 is radially swingable about the swing shaft 82. The swing member 84 has two upward extensions 84a extending upwardly therefrom, and a pin 90 is mounted on substantially upper ends of the upward extensions 84a parallel to the swing shaft 82. The pin 90 is disposed above the swing shaft 82. The roller mechanism 34 has two pin pressers 92, 94 rotatable about the swing shaft 82 under forces applied from respective rods 78a, 80a of the pneumatic cylinders 78, 80. A pressing surface 92a of the pin presser 92 presses the left surface of the pin 90, as shown in FIG. 6, when the rod 78a is contracted, and a pressing surface 94a of the pin presser 94 presses the right surface of the pin 90, also as shown in FIG. 6, when the rod 80a is contracted.

Two downward extensions 76a extend downwardly from the base 76 and are disposed between the two upward extensions 84a. The pressing surfaces 92a, 94a (see FIG. 6) are disposed between the two downward extensions 76a.

A rotation limiting member 96 is mounted on the thrust rotating member 74 and has a recess 96a defined in an upper surface thereof. A small tooth 98 that projects downwardly from the mount member 70 is disposed in the recess 96a. The small tooth 98 has a width smaller than the width of the recess 96a, providing a gap therebetween through which the thrust rotating member 74 is rotatable in a thrust direction. The thrust direction refers to a direction perpendicular to the axis C2 of the roller 48 itself, and a direction about the axis C1 (see FIG. 6) of the third arm 46. The mount member 70 is fastened to the third arm 46 by a bolt 100, which may double as the aforementioned small tooth 98.

The holder connector 88 has two upper and lower clamps 102, 104 confronting each other. The clamps 102, 104 hold an aluminum pipe 106 interconnecting the swing member 84 and the holder 86. The aluminum pipe 106 has an annular groove 106a defined in a surface thereof.

The roller 48 has opposite ends rotatably held by the holder 86. A tube 22a connected to the coating material pipe 22 and the water pipe 26 communicates with the interior of the roller 48 through an end of the holder 86. The roller 48 is removably mounted on the holder 86.

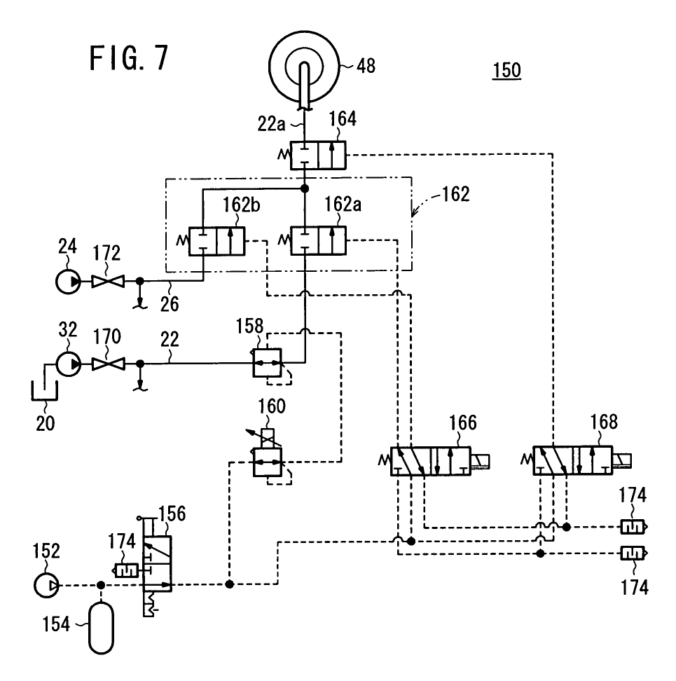

As shown in FIG. 7, a composite hydraulic and pneumatic circuit (supply mechanism) 150 for supplying the protective layer forming material to the roller 48 includes a compressor 152, an air tank 154 connected to the outlet port of the compressor 152, a manually operated pneumatic charge valve 156 for selectively supplying and blocking a pneumatic pressure, a regulator control valve 160 for reducing a secondary pressure with an electric signal supplied from the control console 18, and a regulator 158, which is pilot-controlled by the secondary pressure of the regulator control valve 160, for reducing the pressure in the coating material pipe 22.

The composite circuit 150 also has an MCV (Material Control Valve) 162 to which the secondary pipe of the regulator 158 and the water pipe 26 are connected, and a trigger valve 164 disposed between the secondary side of the MCV 162 and the roller 48. The MCV 162 has switching valves 162a, 162b for selectively bringing the coating material pipe 22 and the water pipe 26 into and out of communication with each other. The switching valves 162a, 162b have respective secondary sides communicating with each other. Broken lines in FIG. 7 represent pneumatic pipes.

The MCV 162, the trigger valve 164, and the regulator control valve 160 need not necessarily be limited to pneumatic pilot-operated valves, but may also be constituted by valves that are actuatable by electric solenoids or the like.

The composite circuit 150 further includes an MCV switching solenoid-operated valve 166 for selectively supplying the pneumatic pressure from the pneumatic charge valve 156 to pilot-operate the switching valves 162a, 162b, and a trigger switching solenoid-operated valve 168 for pilot-operating the trigger valve 164. When supplied with an electric signal from the control console 18, the MCV switching solenoid-operated valve 166 opens either one of the switching valves 162a, 162b, while closing the other of the switching valves 162a, 162b, for selectively supplying water and the protective layer forming material to the trigger valve 164.

In response to an electric signal from the control console 18, the trigger switching solenoid-operated valve 168 selectively opens and closes the trigger valve 164 to supply water or the protective layer forming material to the roller 48.

Manual shut-off valves 170, 172 are connected respectively to the coating material pipe 22 and the water pipe 26. The shut-off valves 170, 172 are normally open.

Silencers 174 are connected to respective air outlet ports of the composite circuit 150 for reducing discharged air noise. The compressor 152, the pump 32, and the water source 24 are combined with respective relief valves (not shown) for preventing undue pressure buildup.

The compressor 152, the air tank 154, the water source 24, and the pump 32 of the composite circuit 150 are shared by the robots 16a, 16b, 16c. Other devices are individually associated with the robots 16a, 16b, 16c.

A process of coating a vehicle 14 with the protective layer forming material, using the coating system 10 thus constructed, shall be described below.

First, the robots 16a, 16b, 16c are trained for operation. The robots 16a, 16b, 16c are assigned to an engine hood 14a (see FIG. 1), a roof 14b, and a rear roof area 14c behind a sunroof opening 14d, respectively, and are trained to apply the protective layer forming material to the assigned areas. Teaching data, by which the robots 16a, 16b, 16c are trained, is recorded in a data storage area of the control console 18, and held therein. If the vehicle 14 is a sedan, then the robot 16c is assigned to a trunk area.

The vehicle 14, which has been coated with the protective layer forming material by the robots 16a, 16b, 16c, is conveyed to a next process by the conveying line 12. The robots 16a, 16b, 16c are retracted to a standby attitude out of interference with the vehicle 14, and wait until a next vehicle 14 is conveyed. At this time, the trigger valve 164 is closed to halt supply of the protective layer forming material.

The applied protective layer forming material is dried naturally or by applying a flow of air, thus forming a peelable protective layer, which protects the painted area of the vehicle 14.

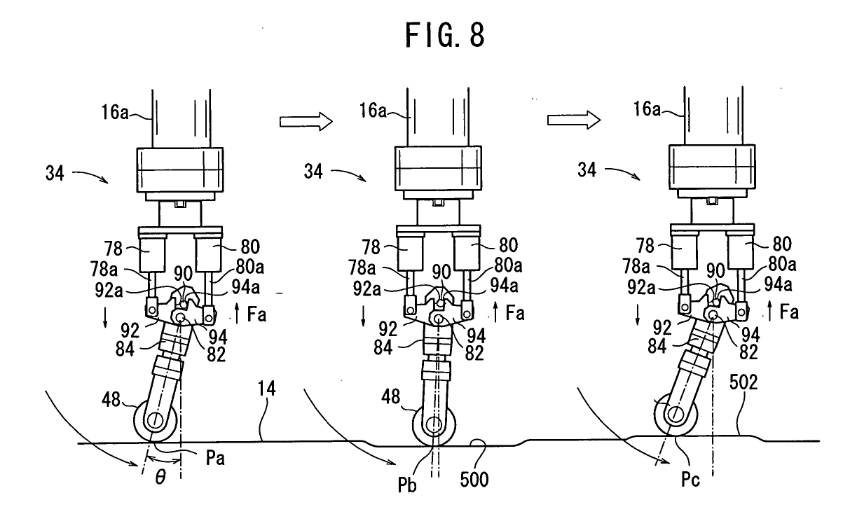

As shown in FIG. 8, the third arm 46 (see FIG. 3) of the robot 16a is spaced from the surface of the vehicle 14 by a suitable distance, or more specifically, the swing member 84 is trained to be inclined through a predetermined angle θ at a flat location Pa, and the third arm 46 is moved parallel to the surface of the vehicle 14 from the flat location Pa. A process for setting the inclined angle θ will be described later.

At a location Pb within a shallow recess 500 on a surface contiguous to the flat location Pa, the third arm 46 may be moved parallel to the surface at the flat location Pa. Furthermore, at a location Pc existing on a low land 502, on a surface contiguous to the flat location Pa, the third arm 46 may also be moved parallel to the surface at the flat location Pa. In this manner, the recess 500 and the land 502 may be ignored, and the inclined angle of the swing member 84 may be somewhat varied. Thus, it is easy to train the robot 16b, since the shallow recess 500 and the relatively low land 502 may be ignored.

The robot is trained to finish the process of applying the protective layer forming material, within a tact time that is preset for each vehicle 14 on the conveying line 12.

For coating the vehicle 14 with the protective layer forming material, the tank 20 (see FIG. 7) and the coating material pipe 22 are heated to a suitable temperature by a given heater, and the compressor 152, the water source 24, and the pump 32 are operated. The robots 16a, 16b, 16c wait in a standby attitude, out of interference with the vehicle 14, and the pneumatic charge valve 156 is opened.

A vehicle 14 that has been painted is conveyed by the conveying line 12 and stopped in the vicinity of the robots 16a, 16b, 16c. The control console 18 recognizes that the vehicle 14 has been conveyed through a signal, which is supplied from the conveying line 12, or by a sensor (not shown), and operates the robots 16a, 16b, 16c based on the teaching data.

At this time, the control console 18 controls the regulator control valve 160 through the regulator 158 (see FIG. 7), so that an appropriate pressure is developed in the coating material pipe 22. The control console 18 also controls the MCV 162 through the MCV switching solenoid-operated valve 166, so as to connect the coating material pipe 22 and disconnect the water pipe 26. Furthermore, the control console 18 operates the trigger switching solenoid-operated valve 168 to open the trigger valve 164. When the control console 18 is thus operated, the protective layer forming material is supplied to the roller 48 of the roller mechanism 34 while being kept under a suitable pressure and at a suitable temperature, such that a suitable amount of the protective layer forming material seeps out to the surface of the roller 48.

Then, for applying the protective layer forming material to a flat surface of the vehicle 14, while moving the robot 16a to the right as shown in FIG. 8, air is supplied to the right pneumatic cylinder 80 to generate a relatively weak force Fa in a direction to contract the rod 80a, while air also is supplied to the left pneumatic cylinder 78 to extend the rod 78a. The pressing surface 94a of the right pin presser 94 presses a right side surface of the pin 90 under a relatively weak force, while the pressing surface 92a of the left pin presser 92 is spaced from the pin 90.

Accordingly, the swing member 84 and the roller 48 are subjected to a force applied counterclockwise about the swing shaft 82, and the roller 48 is pressed against the surface of the vehicle 14 under a suitable pressing force. The force Fa may be adjusted depending on the location to which the roller 48 is applied, and the method by which the roller 48 is moved.

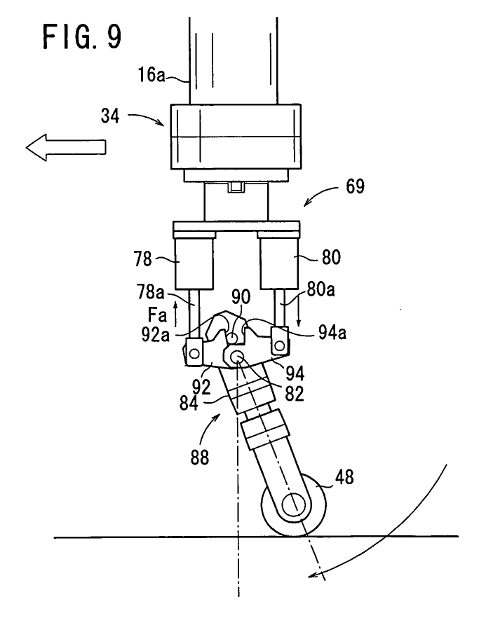

For applying the protective layer forming material to the vehicle 14, while moving the robot 16a to the left as shown in FIG. 9, air is supplied to the left pneumatic cylinder 78 to generate a relatively weak force Fa in a direction to contract the rod 78a, while air is supplied to the right pneumatic cylinder 80 to extend the rod 80a. The pressing surface 92a of the left pin presser 92 presses a left side surface of the pin 90 under a relatively weak force, while the pressing surface 94a of the right pin presser 94 is spaced from the pin 90.

Accordingly, the swing member 84 and the roller 48 are subjected to a force applied clockwise about the swing shaft 82, and the roller 48 is pressed against the surface of the vehicle 14 under a suitable pressing force.

Since the direction of flow and air pressure supplied to the pneumatic cylinders 78, 80 are controlled depending on the direction in which the robot 16a travels, the roller 48 can be pressed against the surface of the vehicle 14 under a suitable pressing force. Specifically, the weight of the roller 48 is effectively utilized as a pressing force, and any shortage in the pressing force, which cannot adequately be provided by the weight of the roller 48 itself, is compensated for by either the pneumatic cylinder 78 or the pneumatic cylinder 80. The roller 48 can be brought into intimate contact with a surface of the vehicle 14 to be coated, even when the surface of the vehicle 14 is not horizontal.

Therefore, the roller 48 is prevented from rotating idly or from jumping when passing over the recess 500 or the land 502. As described above, the protective layer forming material tends to seep out from the roller 48. At this time, since the roller 48 is swingable about the swing shaft 82, the roller 48 is reliably held in abutment against the recess 500 and the land 502, for uniformly applying the protective layer forming material. Specifically, when the roller 48 passes over the recess 500 or the land 502, the rods 78a and 80a are extended or contracted, depending on the depth of the recess 500 or the height of the land 502. Because the pneumatic cylinders 78, 80 employ highly compressible air as an actuating fluid, the pneumatic cylinders 78, 80 operate flexibly and can easily absorb external force variations.

Even in an unexpected situation, if the robot 16a operates slightly out of a predetermined trained path, causing the third arm 46 to move more closely toward the surface of the vehicle 14, an excessive force is not applied to the vehicle 14, because the roller 48 is movable toward and away from the surface of the vehicle 14, and moreover the pressing force applied to the surface of the vehicle 14 is controlled by the air pressure supplied to the pneumatic cylinders 78, 80.

The pin presser 92 coupled to the rod 78a of the pneumatic cylinder 78, and the pin presser 94 coupled to the rod 80a of the pneumatic cylinder 80, apply pressing forces to the swing member 84 through the pin 90 in respective opposite directions, so that the swing member 84 can operate appropriately even if it is inclined in a clockwise or counterclockwise direction. Therefore, the roller 48 can apply the protective layer forming material while it is moving to the right or to the left.

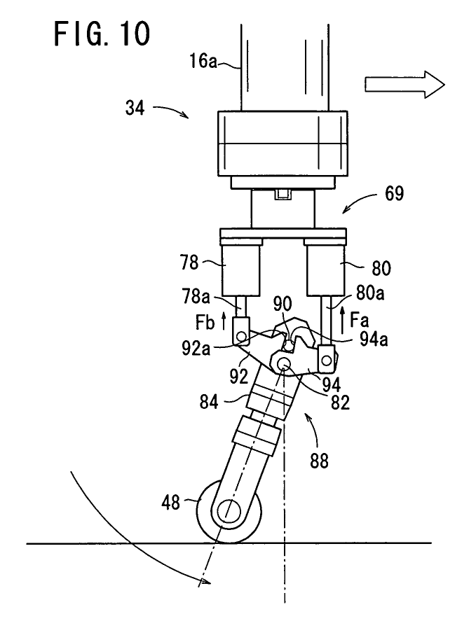

As shown in FIG. 10, both the rod 78a of the pneumatic cylinder 78 and the rod 80a of the pneumatic cylinder 80 may be contracted. For example, for moving the robot 16a to the right in FIG. 10, a relatively weak force Fa is generated in a direction to contract the rod 80a, while a very weak force Fb is generated in a direction to contract the rod 78a. The force Fa is set to be greater than the force Fb (Fa>Fb), while such forces Fa, Fb may be set to appropriate values in order to press the roller 48 against the surface of the vehicle 14 under an appropriate force.

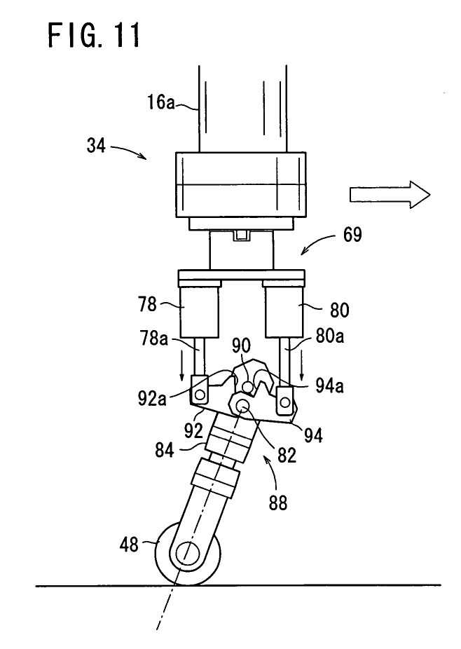

As shown in FIG. 11, both the rod 78a of the pneumatic cylinder 78 and the rod 80a of the pneumatic cylinder 80 may be extended. When both rods 78a and 80a are extended, both the pressing surface 92a of the pin presser 92 and the pressing surface 94a of the pin presser 94 are spaced from the pin 90, and no force is applied to the swing member 84. Therefore, the roller 48 presses the surface of the vehicle 14 solely under its own weight. If the roller 48 is relatively heavy and can apply a sufficient pressing force to the surface of the vehicle 14, then both of the rods 78a, 80a may be extended to make the swing member 84 swingable.

Coating processes when the roller 48 is rolled over a curved area of the vehicle 14, as well as when the roller 48 is rolled over an area having grooves 504 therein, shall be described below.

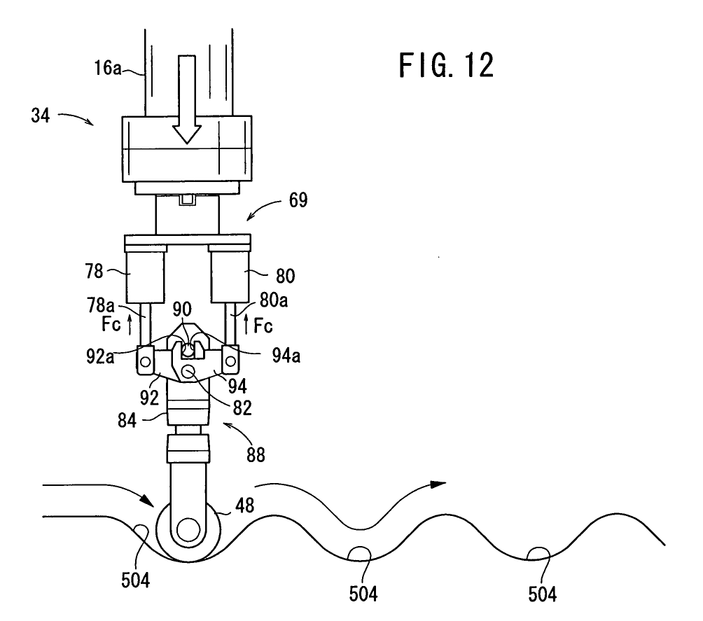

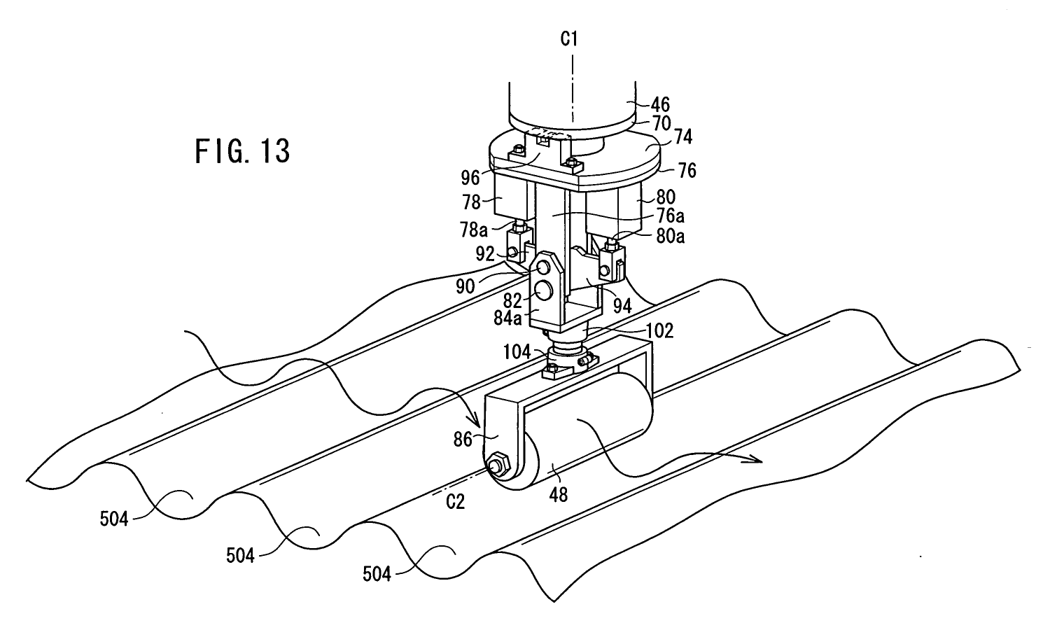

As shown in FIGS. 12 and 13, when the protective layer forming material is to be applied to relatively deep grooves 504 having small widths, both the rod 78a and the rod 80a may be contracted under a strong force Fc (see FIG. 12).

In this case, the swing member 84 is oriented in alignment with the axis C1 (see FIG. 6), due to a dynamic balance, and does not swing significantly to the left or right, but rather is held in a locked state. With the swing member 84 thus held in the locked state, the roller 48 is pressed relatively strongly against the groove 504, thereby causing the protective layer forming material to ooze out from the roller 48 and be applied to the groove 504. At this time, the protective layer forming material is applied while the roller 48 is moved at a lower speed, as compared to the speed thereof when the protective layer forming material is applied to a flat surface of the vehicle 14 by the roller 48.

As a result, since the roller 48 is brought into more reliable close contact with the surface of the vehicle 14 having deep grooves 504 formed therein, the protective layer forming material can be applied more appropriately.

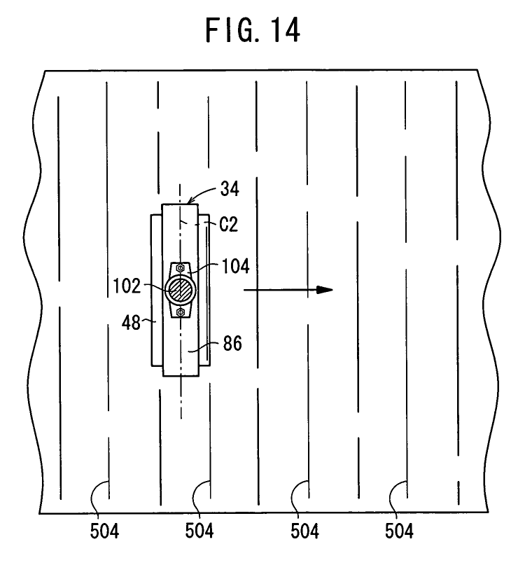

As shown in FIG. 14, when the protective layer forming material is to be applied to a surface of the vehicle 14 having deep grooves 504 formed therein, the axis C2 of the roller 48 of the roller mechanism 34 is oriented substantially parallel to the direction in which the grooves 504 extend, so that the roller 48 can be brought into close contact with the deep grooves 504 along their shape. As a result, the protective layer forming material can reliably be applied to the surface of the vehicle 14 having such deep grooves 504 therein.

Specifically, when the protective layer forming material is applied to the surface of the vehicle 14 having deep grooves 504 formed therein, the roller 48 is rolled (i.e., moved) at a speed lower than when the protective layer forming material is applied to flat surfaces of the vehicle 14, and further, the axis of the roller 48 is oriented substantially parallel to the direction in which the grooves 504 extend. Consequently, the surface of the vehicle 14 having such grooves 504 therein can reliably be coated with the protective layer forming material.

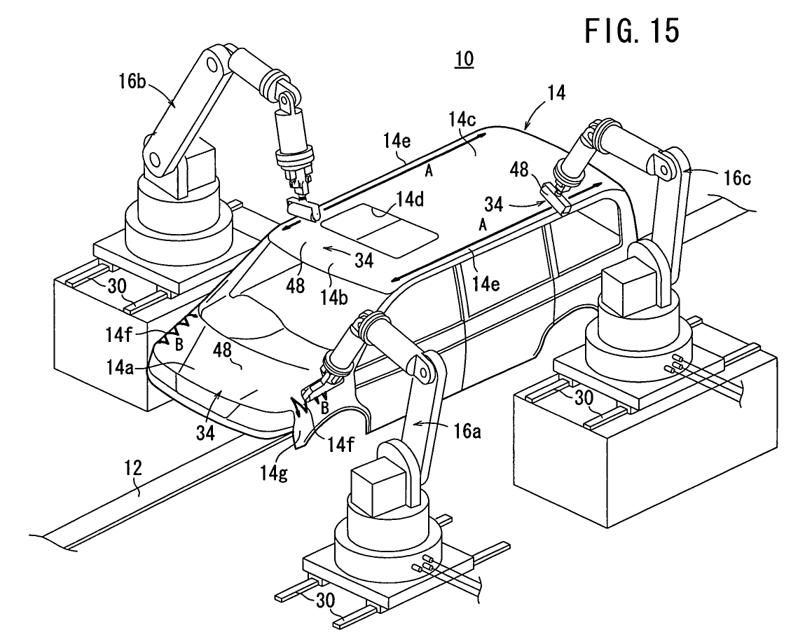

As shown in FIG. 15, when the protective layer forming material is applied to longitudinally long areas of the vehicle 14, such as roof edges e (see FIGS. 1 and 2), the rollers 48 of the roller mechanisms 34 are pressed against the surfaces of the roof edges e, while the robots 16b, 16c holding the roller mechanisms 34 are moved along the slide rails 30 (in the direction indicated by arrow A).

Consequently, surfaces of the roof edges e, which extend a greater length in the longitudinal direction of the vehicle 14, can reliably be coated with the protective layer forming material.

When the protective layer forming material is applied to areas having a large curvature or a complex shape, such as edges 14f of the engine hood 14a (see FIGS. 1 and 2), as shown in FIGS. 2 and 15, the rollers 48 of the roller mechanisms 34 are pressed against the vehicle 14 and are moved in relatively small reciprocating strokes (in the direction indicated by arrow B) between the engine hood 14a and front side panels 14g. Consequently, surfaces of such edges 14f, which have a relatively large curvature, can appropriately be coated with the protective layer forming material. Areas having complex shapes can also more appropriately be coated with the protective layer forming material, since the roller 48 is moved in relatively small reciprocating strokes.

For applying the protective layer forming material to areas having a large curvature or areas having complex shapes, the roller 48, which is pressed against the surface of the vehicle 14, is rolled (i.e., moved) at a speed lower than when the protective layer forming material is applied to flat surfaces of the vehicle 14.

For moving the roller 48 over relatively long distances while keeping the roller 48 out of contact with the surface of the vehicle 14, the swing member 84 may be locked. When the swing member 84 is locked in this manner, it does not swing unexpectedly, and the swing member 84 can be moved over long distances at higher speeds.

With the method of applying a protective layer forming material according to the present invention, as described above, the roller mechanisms 34 including the rollers 48 are operated by the robots 16a, 16b, 16c, while the rollers 48 are supplied with the protective layer forming material. Thus, the process of applying the protective layer forming material can be automated and the coating quality can be made uniform.

The roller mechanism 34 includes a function to press the roller 48 against the surface of the vehicle 14, while allowing the roller 48 to move upwardly and downwardly passively, depending on convexities and concavities over which the roller 48 rolls. Therefore, the roller 48 can be held in close contact with the outer surface of the vehicle 14, for appropriately applying the protective layer forming material.

When the protective layer forming material is applied to the surface of the vehicle 14 having deep grooves 504 therein, the roller 48 is rolled (i.e., moved) at a speed lower than when the protective layer forming material is applied to flat surfaces of the vehicle 14, and the axis of the roller 48 is oriented substantially parallel to the direction in which the grooves 504 extend. By moving the roller 48 in a direction substantially perpendicular to the axis of the roller 48, the surface of the vehicle 14 having such grooves 504 therein can more reliably be coated with the protective layer forming material.

When the protective layer forming material is applied to areas that extend over a greater length in the longitudinal direction of the vehicle 14, such as the roof edges e of the vehicle 14, the rollers 48 of the roller mechanisms 34 are pressed against surfaces of the roof edges e, and the robots 16b, 16c including the roller mechanisms 34 are moved along the slide rails 30 (in the direction indicated by arrow A). Consequently, the rollers 48 can be held in close contact with the surfaces of the roof edges 14e, in order to apply the protective layer forming material.

When the protective layer forming material is applied to areas having a large curvature or a complex shape, such as the edges 14f of the engine hood 14a (see FIGS. 1 and 2), as shown in FIGS. 2 and 15, the rollers 48 of the roller mechanisms 34 are pressed against the vehicle 14, and are moved in relatively small reciprocating strokes (in the direction indicated by arrow B) between the engine hood 14a and the front side panels 14g. Consequently, the rollers 48 can be held in close contact with the surface of the vehicle 14, in order to apply the protective layer forming material.

In this manner, the protective layer forming material can appropriately be applied depending on the shape and area of the portion of the vehicle that is to be coated with the protective layer forming material.

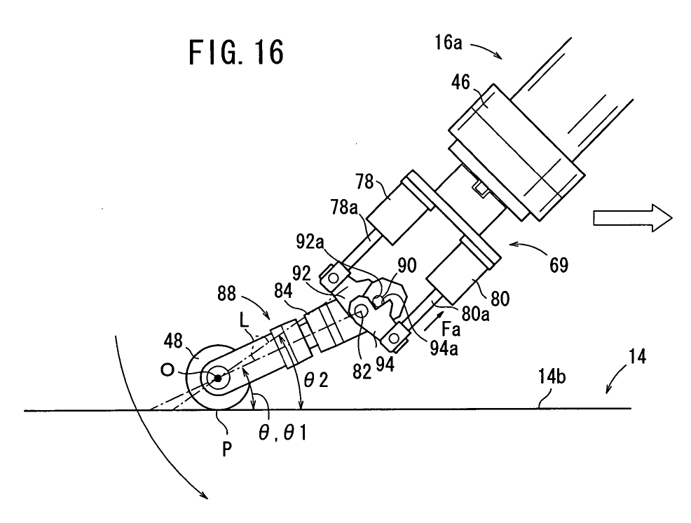

A process of training each of the robots 16a, 16b, 16c to apply the protective layer forming material, depending on the curvature of the surface of the vehicle 14, shall be described in detail below with reference to FIGS. 16 through 21.

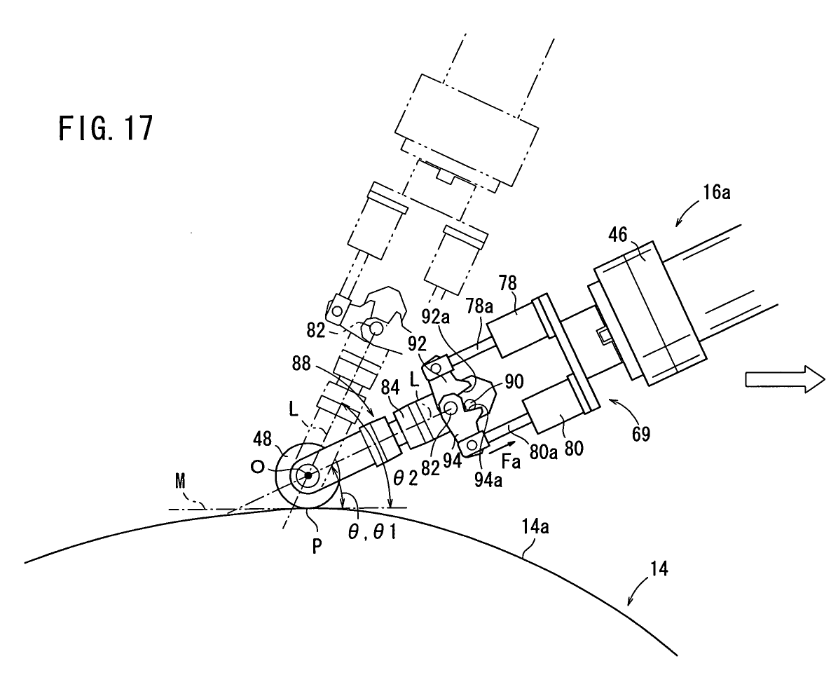

As shown in FIG. 16, it is assumed that a straight line interconnecting the axis of the roller 48 and the swing shaft 82 is represented by L, and the robot is trained to maintain the straight line L tilted with respect to the surface of the vehicle 14 through an appropriate tilt angle θ. The tilt angle θ is based on a surface of the vehicle 14, which is defined as a surface including a tangential line M (see FIG. 17) perpendicular to the axis C2 of the roller 48, at a point P (see FIG. 17) where the roller 48 contacts the vehicle 14.

A maximum angle θ2 (see FIG. 16) for the tilt angle θ is set depending on the curvature of the surface of the vehicle 14. When a substantially flat surface such as the roof 14b or a trunk lid (not shown), for example, is to be coated, the maximum angle θ2 is set to a small value, and the speed at which the robots 16a, 16b, 16c move (that is, the speed at which the roller 48 rolls) is set to a high value. When a surface having a large curvature such as the engine hood 14a (see FIG. 17) is to be coated, the maximum angle θ2 is set to a large value, and the speed at which the robots 16a, 16b, 16c move is set to a low value. The robots 16a, 16b, 16c move in a direction in which the swing member 84 is tilted with respect to the roller 48.

As described above, on a substantially flat surface to be coated, the maximum angle θ2 is set to a small value, effectively utilizing the weight of the roller 48 for applying a pressing force to the vehicle 14. Since the robots 16a, 16b, 16c can be moved at a high speed, a surface having a large area, such as the roof 14b, can be coated within a short period of time. On a surface to be coated which has a large curvature, the maximum angle θ2 is set to a large value to keep the roller 48 in reliable contact with the surface to be coated. In this case, the speed at which the robots 16a, 16b, 16c move is set to a low value. Since, in general, vehicles 14 tend to have relatively few surfaces with large curvatures, the vehicles 14 can still be coated within a predetermined tact time.

According to the results of an experiment that was conducted by the inventor, for a substantially flat surface to be coated, a minimum angle θ1 may be set to 25° and the maximum angle θ2 to 35°, and the tilt angle θ may be selected in a range between the minimum and maximum angles. For a surface having a large curvature that is to be coated, the minimum angle θ1 may be set to 25° and the maximum angle θ2 to 65°, and the tilt angle θ may be selected in a range between these minimum and maximum angles.

Stated otherwise, among the surfaces of the vehicle 14 to be coated with the protective layer forming material, a surface having the smallest curvature may be regarded as a flat surface, wherein the tilt angle θ may be set to a value ranging from 25° to 35° for such a flat surface. For a surface having the greatest curvature from among the surfaces of the vehicle 14 to be coated with the protective layer forming material, the tilt angle θ may be set to a value ranging from 25° to 65°.

The minimum angle θ1 (=25°) for the substantially flat surface, as well as the minimum angle θ1 (=25°) for the surface having a large curvature, are of the same value. This is because the surface having a large curvature may be of a complex shape, and the tilt angle θ may be set to a small value depending on the type of individual vehicle and the surface thereof to be coated.

The speed at which the robots 16a, 16b, 16c move may be set such that it becomes lower proportionally as the tilt angle θ increases. In this manner, the curvature of the surface to be coated, the tilt angle θ, and the speed at which the robots 16a, 16b, 16c move are all related to each other, so that such parameters can easily be set.

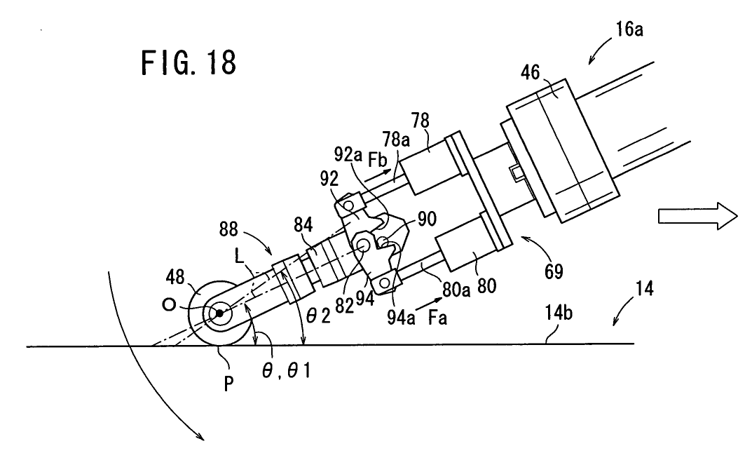

When the robots 16a, 16b, 16c are trained for operation, once the position of the swing shaft 82 has been determined, then the third arm 46 can be set to any desired attitude. Specifically, as shown in FIG. 16, the third arm 46 may be set at a slightly erected attitude, or as shown in FIG. 18, the third arm 46 may be set at an attitude along the axis of the swing member 84.

The robots 16a, 16b, 16c are assigned to the engine hood 14a (see FIG. 1) and the roof 14b, and are trained to apply the protective layer forming material to their assigned areas. Teaching data, by which the robots 16a, 16b, 16c are trained, is recorded in a given storage area and held therein. If the vehicle 14 is a sedan, then the robot 16c may be assigned to a trunk area thereof.

According to the present embodiment, since the maximum angle θ2 for the tilt angle θ is set to a small value for substantially flat surfaces to be coated, the robots 16a, 16b, 16c can be moved at a high speed for efficiently applying the protective layer forming material. Since such substantially flat surfaces can be coated relatively easily, the vehicle can reliably be coated with the protective layer forming material, even when the robots 16a, 16b, 16c move at high speeds.

Because the maximum angle θ2 for the tilt angle θ is set to a large value for surfaces having a large curvature, such surfaces can also reliably be coated with the protective layer forming material.

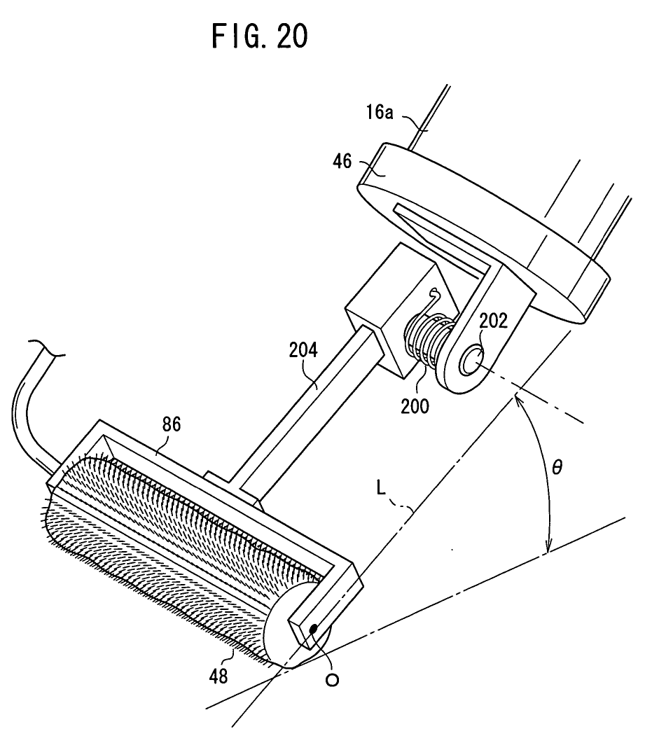

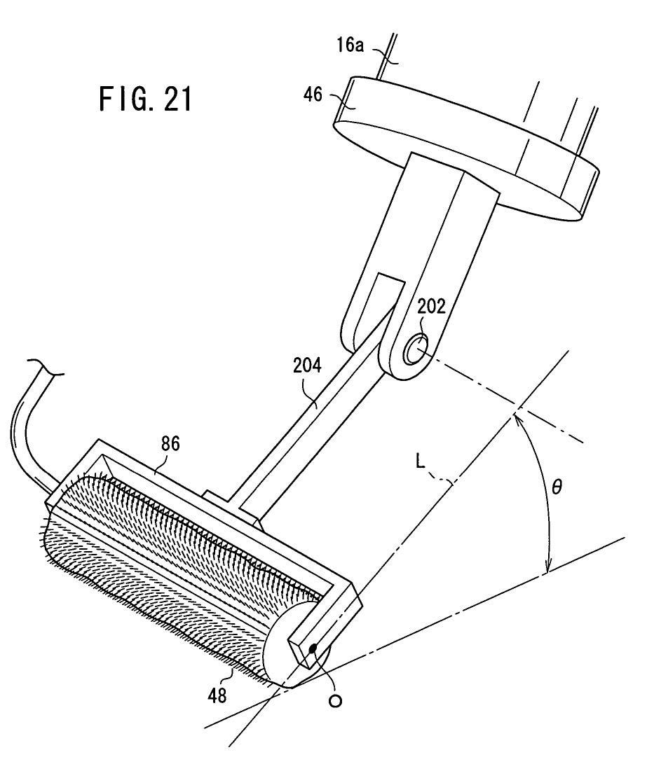

In the above embodiment, pneumatic cylinders 78, 80 have been described, which apply a pressing force to the swing member 84, wherein the roller 48 is held in reliable close contact with the surface of the vehicle 14. The pressing means, however, is not limited to pneumatic cylinders 78, 80. As shown in FIG. 20, for example, a spring 200 may also be employed, and the roller 48 may be pressed against the surface of the vehicle 14 under the resilient force of the spring 200. Alternatively, as shown in FIG. 21, for example, the pressing means may be dispensed with, and only a swinging mechanism may be employed.

With the above arrangements, the tilt angle θ of a swing member 204 may be defined based on a straight line L interconnecting a swing shaft 202 and the axis C2. When the robots 16a, 16b, 16c are trained for operation, for coating a substantially flat surface with the protective layer forming material, the tilt angle θ may be set to a small value, and the speed at which the robots 16a, 16b, 16c move may be set to a high value. For coating a surface having a large curvature with the protective layer forming material, the tilt angle θ may be set to a large value, and the speed at which the robots 16a, 16b, 16c move may be set to a low value.

The above vehicle 14 has been described such that the engine hood 14a has a large curvature and the roof 14b is substantially flat. However, the present invention is also applicable to various other types of vehicles. The maximum angle θ2 for the tilt angle θ need only be set based on curvature of the vehicle surface, and is not limited by the areas of the vehicle 14, such as the engine hood 14a, the roof 14b, etc.

By setting the maximum angle θ2 for the tilt angle θ to a large value depending on the magnitude of curvature of the surface to be coated, the roller 48 can appropriately be pressed depending on the shape of the surface of the vehicle 14.

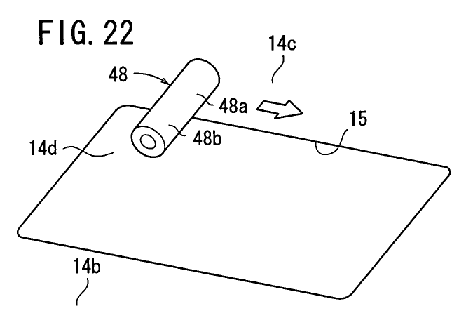

A process for applying the protective layer forming material to an opening edge 15 of a sunroof opening 14d, which may be provided in the vehicle according to the present embodiment, shall be described below with reference to FIGS. 22 through 28.

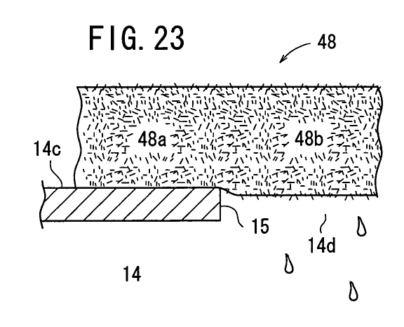

For applying the protective layer forming material to the opening edge 15 of the opening 14d, the roller 48 is generally transported while rolling over the roof and the opening 14d, as shown in FIGS. 22 and 23. Specifically, when a portion of the roller 48 applies the protective layer forming material to the opening edge 15 while rolling over the rear roof area 14c including the opening 14d, for example (see FIG. 22), the portion of the roller 48 is pressed against the rear roof area 14c, and the protective layer forming material that seeps from the pressed side 48a of the roller 48 penetrates into a portion of the roller 48, i.e., a non-pressed side 48b of the roller 48, that lies over the opening 14d as a result of the pressing force, and eventually if left untreated, the protective layer forming material drops through the opening 14d into the vehicle 14 (see FIG. 23).

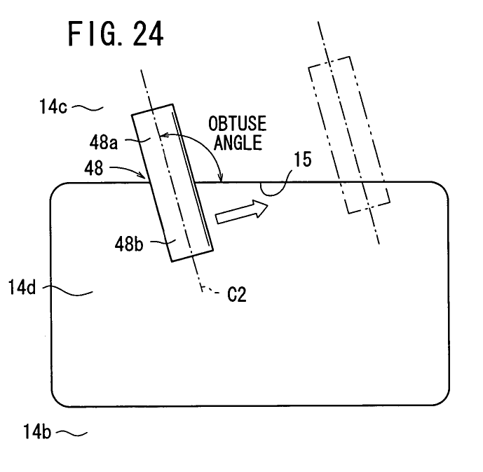

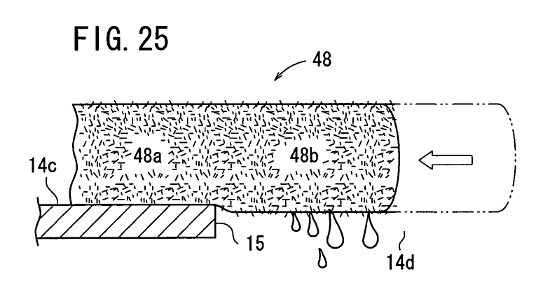

To attempt to overcome the above drawback, the roller 48 may be transported while being inclined at a certain angle to the opening edge 15 and progressively spaced from the opening edge 15, as shown in FIG. 24, to apply the protective layer forming material. Specifically, the axis of the roller 48 is inclined at an obtuse angle to the direction in which the opening edge 15 extends, and the roller 48 is rolled over the rear roof area 14c, as indicated by the arrow. When the roller 48 is thus rolled, the side 48a of the roller 48 that is pressed against the rear roof area 14c becomes progressively larger, whereas the portion of the roller 48 that lies over the opening 14d, i.e., the non-pressed side 48b, becomes progressively smaller. As a result, the protective layer forming material that seeps from the side 48a of the roller 48 that is pressed against the rear roof area 14c fills the non-pressed side 48b, because the non-pressed side 48b becomes small, until finally the protective layer forming material drops into the vehicle 14 (see FIG. 25).

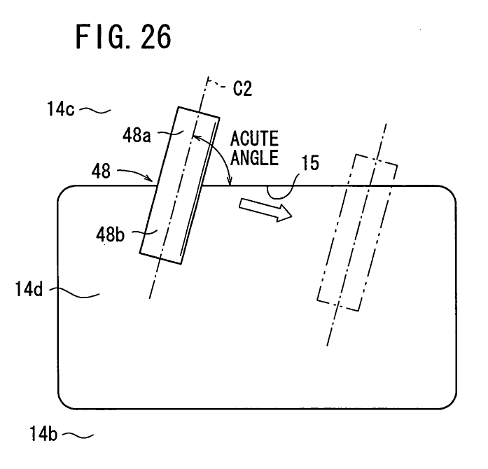

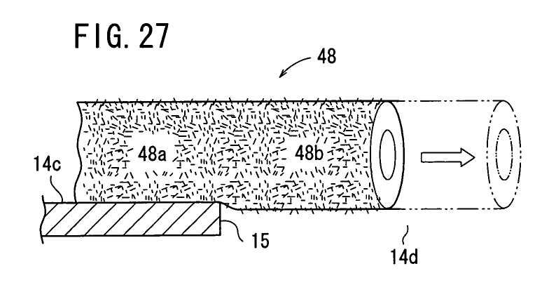

The present embodiment is arranged to avoid the above shortcoming. In contrast to the arrangements described above, the axis of the roller 48 is inclined at an acute angle to the direction in which the opening edge 15 extends (see FIG. 26), while the roller 48 containing the protective layer forming material is rolled. As a result, as the roller 48 moves along the opening edge 15, as indicated by the arrow in FIGS. 26 and 27, the portion of the roller 48 that is positioned over the opening 14d increases. Specifically, the portion 48b that is not pressed against the rear roof area 14c increases, and can sufficiently absorb the protective layer forming material that seeps from the pressed side portion of the roller 48. Therefore, the protective layer forming material does not drop into the vehicle 14.

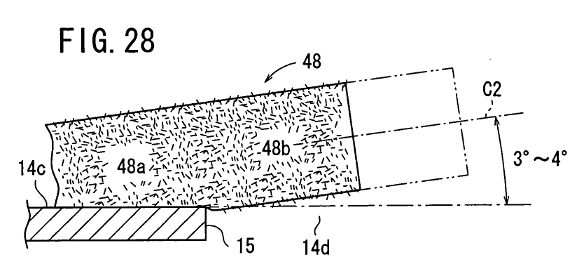

As shown in FIG. 28, it is also preferable to tilt the roller 48 on the surface of the rear roof area 14c, so that the side thereof that lies over the opening 14d is raised by 3° to 4°, for thereby increasing the capacity of the roller 48 to receive and retain the penetrating protective layer forming material.

The robots 16b, 16c are trained to move the roller 48, with the axis of the roller 48 being inclined at an acute angle to the opening edge 15. Specifically, the roller 48 may be inclined at an acute angle to the opening edge 15 through the thrust rotating member 74.

In this manner, the process of coating the outer surface of the vehicle 14 with the protective layer forming material is further automated, and the roller 48 can be held in close contact with the vehicle 14 at all times depending on the shape of surfaces of the vehicle 14 and the area thereof to be coated, for thereby reliably applying the protective layer forming material.

According to the present embodiment, furthermore, when the protective layer forming material is applied to the opening edge 15 of the opening 14d, the axis of the roller 48 is inclined at an acute angle to the direction in which the opening edge 15 extends. Therefore, even during the coating process, the protective layer forming material that moves and penetrates into the roller 48 does not drop into the vehicle 14. A cleaning process, which would otherwise be performed if the protective layer forming material were to drop into the vehicle 14, is not required. Thus, the process of applying the protective layer forming material is simplified as a whole, and the manufacturing cost is lowered.

According to the present embodiment, since a worker does not need to apply the protective layer forming material due to the automated process, the number of process steps is reduced, thereby increasing production efficiency. Further, an air-conditioning system for the worker may be dispensed with. Electric energy required for such an air-conditioning system may also be saved, and therefore the coating system is energy efficient, is more environmentally friendly, and reduces operating costs for the factory.

The thickness of the protective layer forming material applied to the vehicle 14 can be adjusted by controlling the pressure with the regulator 158, the speed of operation of the robots 16a, 16b, 16c, and/or the forces applied to the rods 78a, 80a.

When the protective layer forming material is applied, the vehicle 14 may be an unfinished vehicle, without other components mounted thereon, yet wherein the paint coating for the vehicle 14 has been completed.

The vehicle 14 that has been coated with the protective layer forming material by the robots 16a, 16b, 16c is conveyed to a subsequent station by the conveying line 12. The robots 16a, 16b, 16c are retracted to a standby attitude, out of interference with the vehicle 14, and wait until a next vehicle 14 is conveyed into the coating area. At this time, the trigger valve 164 is closed, in order to stop the supply of the protective layer forming material.

The applied protective layer forming material is dried naturally or by an applied flow of air, thus forming a peelable protective layer that protects the painted areas of the vehicle 14.

If the protective layer forming material comprises an acrylic copolymer, then it can protect a painted area of the vehicle more reliably and can easily be peeled off when it is removed.

The peelable protective layer formed from the protective layer forming material is effective to protect the painted area of the vehicle 14 after the vehicle 14 has been shipped, and also to protect the painted area in the factory. Therefore the peelable protective layer can be used as a substitute for a scratch cover, and several scratch covers having different shapes for different vehicle types can be dispensed with.

Some bumpers of vehicles 14 are colored and do not need to be painted. In this case, the protective layer forming material may be applied to areas other than painted areas such as bumpers.

1. A method of applying a protective layer forming material by rolling a roller mounted on a roller mechanism over a surface of a workpiece, using a trainable coating apparatus disposed near a conveying line for conveying the workpiece, and applying the protective layer forming material in a liquid form to the surface of the workpiece, which is supplied to said roller and which will act as a peelable protective layer after being dried, said method comprising the steps of:
when said roller is rolled over a curved area of said workpiece, rolling said roller at a speed lower than when the roller is rolled over a substantially flat area of the workpiece; and
when said roller is rolled over an area having a groove of said workpiece, orienting an axis of said roller substantially parallel to a direction in which said groove extends, moving said roller in a direction substantially perpendicular to the direction in which said groove extends, pressing said roller against said groove, and rolling said roller at a speed lower than when the roller is rolled over a substantially flat area of the workpiece.

2. A method according to claim 1, wherein said coating apparatus comprises a robot, and said workpiece comprises a vehicle.

3. A method according to claim 1, wherein said roller mechanism has a swinging mechanism for swinging said roller about a swing shaft in a direction perpendicular to said axis of said roller, wherein a maximum angle for a tilt angle of a straight line interconnecting said swing shaft and the axis of said roller, with respect to a surface of said workpiece to be coated, is set to an increased value depending on the magnitude of curvature of said surface of said workpiece to be coated.

4. A method according to claim 3, wherein said tilt angle is set at a value ranging from 25° to 35° for a surface to be coated having smallest curvature, and said tilt angle is set at a value ranging from 25° to 65° for a surface to be coated having greatest curvature.

5. A method according to claim 3, wherein said coating apparatus is moved at a lower speed as said tilt angle increases.

6. A method according to claim 1, utilizing a pressing means for pressing said roller against the surface of the workpiece to be coated.

7. A method according to claim 1, wherein said protective layer forming material comprises an acrylic copolymer as a chief component.

8. A method of applying a protective layer forming material by rolling a roller mounted on a roller mechanism over a surface of a workpiece, using a trainable coating apparatus disposed near a conveying line for conveying the workpiece, and applying the protective layer forming material in a liquid form to the surface of the workpiece, which is supplied to said roller and which will act as a peelable protective layer after being dried, said method comprising the steps of:
when said roller mounted on said roller mechanism is pressed against and rolled over said workpiece near an opening edge that defines an opening in the workpiece, setting an axis of said roller at an acute angle to a direction in which said opening edge extends; and
rolling said roller along said opening edge to apply the protective layer forming material to the surface of said workpiece near said opening by said coating apparatus

9. A method according to claim 8, wherein said coating apparatus comprises a robot, and said workpiece comprises a vehicle.

10. A method according to claim 8, wherein said protective layer forming material comprises an acrylic copolymer as a chief component.

11. A method of applying a protective layer forming material by rolling a roller mounted on a roller mechanism over a surface of a workpiece, using a trainable coating apparatus disposed near a conveying line for conveying the workpiece, and applying the protective layer forming material in a liquid form to the surface of the workpiece, which is supplied to said roller and which will act as a peelable protective layer after being dried, said method comprising the steps of:
when said roller mounted on said roller mechanism is pressed against and rolled over said workpiece near an opening edge that defines an opening in the workpiece, inclining said roller to press one end of the roller against the surface of said workpiece, while allowing the other end of the roller to float over said opening; and
rolling said roller along said opening edge to apply the protective layer forming material to the surface of said workpiece near said opening by said coating apparatus.

12. A method according to claim 11, wherein said coating apparatus comprises a robot, and said workpiece comprises a vehicle.

13. A method according to claim 11, wherein said protective layer forming material comprises an acrylic copolymer as a chief component.
